(19) United States
(12) Patent Application Publication
(10) Pub. No.: US 2020/0401299 A1
(43) Pub. Date: Dec. 24, 2020

(54) SYSTEMS AND METHODS FOR PROVIDING A USER INTERFACE FOR DYNAMICALLY GENERATING CHARTS

(71) Applicant: Facebook, Inc., Menlo Park, CA (US)

(72) Inventor: Dylan Hafertepen, Seattle, WA (US)

(21) Appl. No.: 16/121,464

(22) Filed: Sep. 4, 2018

(51) Int. Cl. G06F 3/0484; G06Q 50/00; G06N 99/00; G06T 11/20; G06F 3/0482

(52) U.S. Cl. CPC G06F 3/04845; G06Q 50/01; G06F 17/276; G06T 11/206; G06F 3/0482; G06N 99/005

(57) ABSTRACT

Systems, methods, and non-transitory computer readable media can provide a user interface for generating charts, the user interface including a toolbar for indicating a plurality of options for generating a chart. A first visualization of data can be generated, for display in the user interface, based on a first chart type and one or more values for at least some of the plurality of options. One or more changed values can be received for at least some of the plurality of options. A second visualization of data can be dynamically generated, for display in the user interface, based on a second chart type and the one or more changed values.

### FIELD OF THE INVENTION

The present technology relates to the field of social networks. More particularly, the present technology relates to techniques for visualization of data associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In one example, a content item can be presented on a profile page of a user. As another example, a content item can be presented through a feed for a user to access. In some cases, a social networking system can provide various visualizations of data. For example, data relating to content items can be displayed to users using different types of charts.

### SUMMARY

Various embodiments of the present technology can include systems, methods, and non-transitory computer readable media configured to provide a user interface for generating charts, the user interface including a toolbar for indicating a plurality of options for generating a chart. A first visualization of data can be generated, for display in the user interface, based on a first chart type and one or more values for at least some of the plurality of options. One or more changed values can be received for at least some of the plurality of options. A second visualization of data can be dynamically generated, for display in the user interface, based on a second chart type and the one or more changed values.

In some embodiments, at least one of the first chart type and the second chart type is determined based on a machine learning model.

In certain embodiments, the machine learning model is trained to determine a chart type for particular data based on a data type associated with the particular data.

In an embodiment, the data in the first visualization and the data in the second visualization include one or more events.

In some embodiments, the one or more events in the first visualization or in the second visualization are split by one or more attributes associated with the one or more events.

In certain embodiments, the first chart type and the second chart type include one or more of: a line chart, a bar chart, a pie chart, a funnel chart, a histogram, a scatter plot, a table, or a cohort chart.

In an embodiment, the plurality of options for generating a chart relates to one or more of: a chart type, an event, an attribute, or a time window.

In some embodiments, the event includes one or more of: user activity, new user activity, page views, content views, application installs, application launches, search, post comments, post reactions, post shares, purchases, unique purchases, add to cart, checkout, initiate check out, or call-to-action selected, and the attribute includes one or more of: gender, age, language, traffic source, region, unique users, new users, stickiness, browser, browser version, device type, device model, device operating system (OS), or application version.

In certain embodiments, the toolbar includes one or more input UI elements associated with the plurality of options, and an automated suggestion for an input entered in the one or more input UI elements is generated.

In an embodiment, the generating an automated suggestion is based on natural language processing.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including an example dynamic data visualization module configured to provide dynamic visualization of data, according to an embodiment of the present technology.

FIG. 2A illustrates an example dynamic chart generation module configured to provide dynamically changing charts, according to an embodiment of the present technology.

FIG. 2B illustrates an example chart type determination module configured to train a machine learning model to predict a chart type for data, according to an embodiment of the present technology.

FIGS. 3A-3E illustrate example user interfaces for providing dynamic visualization of data, according to an embodiment of the present technology.

FIG. 4 illustrates an example first method for providing dynamic visualization of data, according to an embodiment of the present technology.

FIG. 5 illustrates an example second method for providing dynamic visualization of data, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

### Providing a User Interface for Dynamically Generating Charts

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access.

In some cases, a social networking system can provide various visualizations of data. For example, data relating to content items, such as advertisements, can be displayed to users using different types of charts. However, conventional approaches specifically arising in the realm of computer technology may not provide functionality to dynamically switch between different types of charts to illustrate data. For example, if some data is shown in a bar chart and a user wants to see the same data in a line chart, the user may have to create a new line chart for the data. In some cases, creating a new type of chart for the same data can require users to burdensomely navigate through a menu and select numerous menu items for creating different types of charts. Accordingly, conventional approaches of providing visualizations of data can be inefficient and cumbersome.

An improved approach rooted in computer technology can overcome the foregoing and other disadvantages associated with conventional approaches specifically arising in the realm of computer technology. Based on computer technology, the present technology can provide a single user interface (UI) that allows dynamic changes in visualization of data. For example, the user interface can display data in a chart and can dynamically switch between different types of charts to display the data. The user interface can also dynamically change data to be displayed in a chart. A toolbar can be provided in the user interface that allows a user to select or input various options for generating a chart. Examples of options for generating a chart can include a chart type, one or more events (e.g., user activity, page views, etc.), one or more pattributes (e.g., gender, unique users, etc.), a time window (e.g., day(s), week(s), month(s), etc.), etc. The user interface can dynamically change a displayed chart based on changes to the various options. In some embodiments, machine learning techniques can be used to automatically determine a chart type to be displayed in the user interface based on the type of data to be displayed. For example, a map can be determined to be the chart type for location data. In some embodiments, automated suggestions for options for generating a chart can be provided as a user provides an input for the options, for example, based on natural language processing. For example, if a user begins entering text in a text field for events, suggestions relating to events can be provided. In this manner, the present technology can facilitate dynamic changes in visualization of data according to users' preferences in real or near real time. Additional details relating to the present technology are provided below.

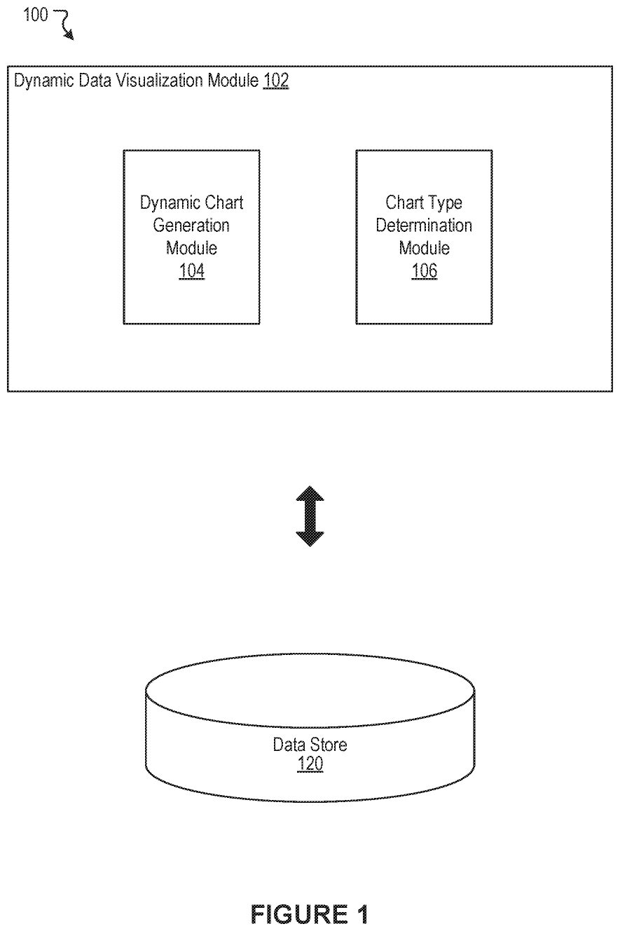

FIG. 1 illustrates an example system 100 including an example dynamic data visualization module 102 configured to provide dynamic visualization of data, according to an embodiment of the present technology. The dynamic data visualization module 102 can include a dynamic chart generation module 104 and a chart type determination module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the dynamic data visualization module 102 can be implemented in any suitable combinations. While the present technology is described in connection with data associated with a social networking system for illustrative purposes, the present technology can apply to any other type of system and/or data.

The dynamic chart generation module 104 can provide dynamically changing charts. The dynamic chart generation module 104 can provide a single UI that supports dynamic switching between different chart types and/or different data. A user can specify or select options for generating a chart for particular data, and the dynamic chart generation module 104 can generate a chart within the UI based on the options. The user can subsequently change some or all of the options for generating a chart, and the chart can be dynamically updated within the UI based on the changed options. Functionality of the dynamic chart generation module 104 is described in more detail herein.

The chart type determination module 106 can train a machine learning model to predict a chart type for data. For example, the chart type determination module 106 can predict a chart type for particular data based on the machine learning model when a user has not specified a chart type in options for generating a chart. Functionality of the chart type determination module 106 is described in more detail herein.

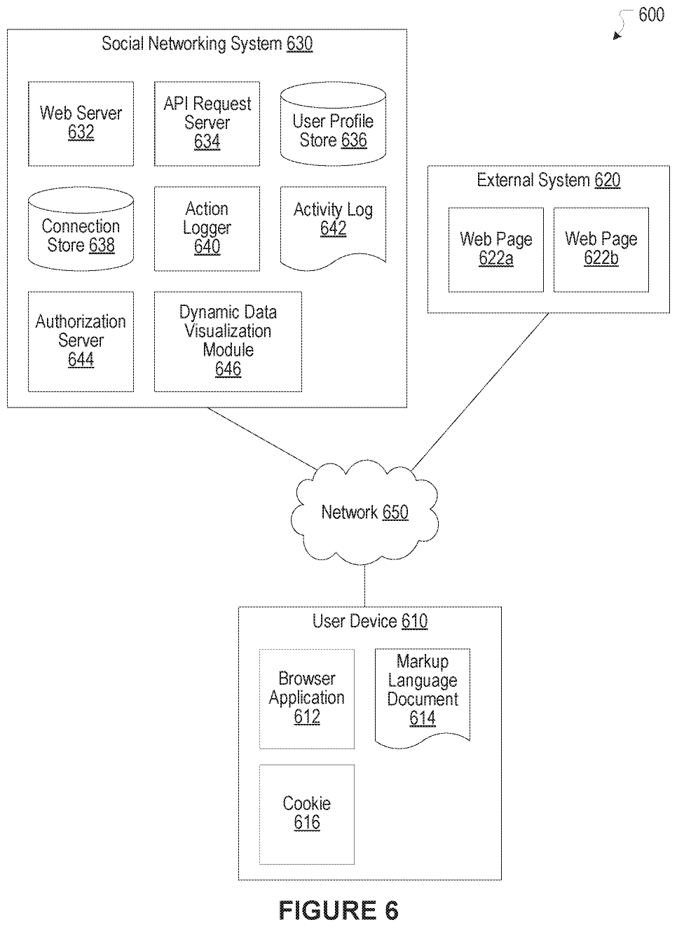

In some embodiments, the dynamic data visualization module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the dynamic data visualization module 102 can be, in part or in whole, implemented as software running on one or more computing devices or systems, such as on a server system or a client computing device. In some instances, the dynamic data visualization module 102 can be, in part or in whole, implemented within or configured to operate in conjunction or be integrated with a social networking system (or service), such as a social networking system 630 of FIG. 6. Likewise, in some instances, the dynamic data visualization module 102 can be, in part or in whole, implemented within or configured to operate in conjunction or be integrated with a client computing device, such as the user device 610 of FIG. 6. For example, the dynamic data visualization module 102 can be implemented as or within a dedicated application (e.g., app), a program, or an applet running on a user computing device or client computing system. The application incorporating or implementing instructions for performing functionality of the dynamic data visualization module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The data store 120 can be configured to store and maintain various types of data, such as the data relating to support of and operation of the dynamic data visualization module 102. The data maintained by the data store 120 can include, for example, information relating to dynamic visualization, charts, chart types, events, attributes, time windows, auto suggestion, machine learning, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the dynamic data visualization module 102 can be configured to communicate and/or operate with the data store 120. In some embodiments, the data store 120 can be a data store within a client computing device. In some embodiments, the data store 120 can be a data store of a server system in communication with the client computing device.

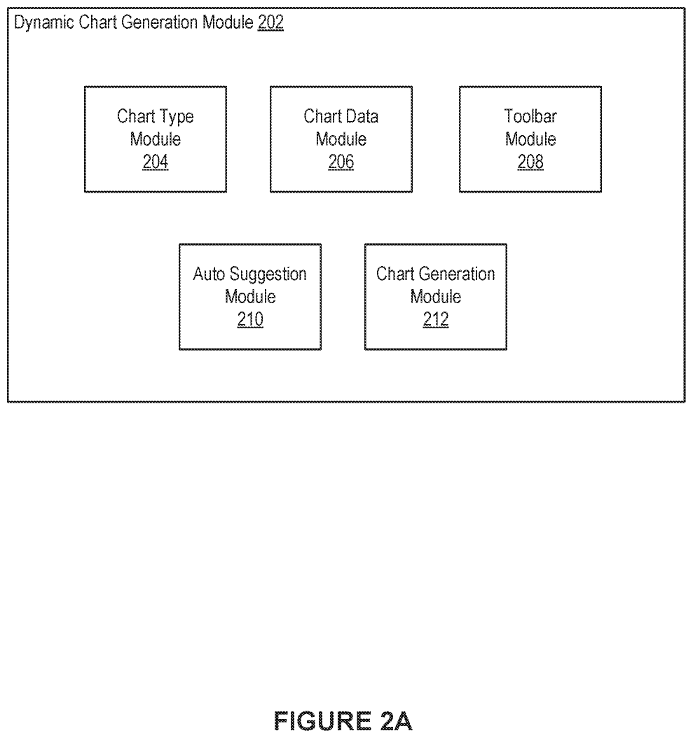

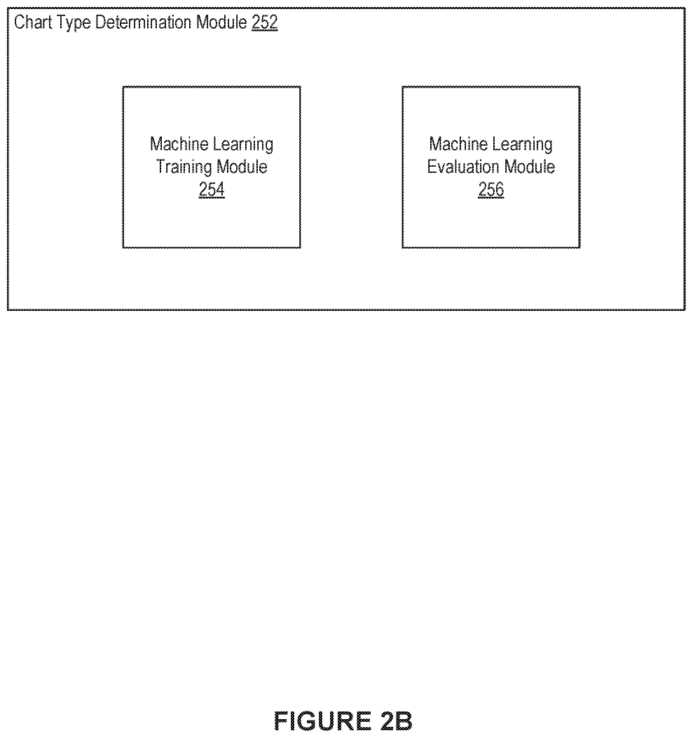

FIG. 2A illustrates an example dynamic chart generation module 202 configured to provide dynamically changing charts, according to an embodiment of the present technology. In some embodiments, the dynamic chart generation module 104 of FIG. 1 can be implemented with the example dynamic chart generation module 202. As shown in the example of FIG. 2A, the example dynamic chart generation module 202 can include a chart type module 204, a chart data module 206, a toolbar module 208, an auto suggestion module 210, and a chart generation module 212. The dynamic chart generation module 202 can provide a single UI that supports dynamic switching or “pivoting” between different chart types and/or different data. For example, the dynamic chart generation module 202 can provide various options for generating a chart, for example, in a toolbar. The various options for generating a chart can relate to which chart type to use as well as which data to display. A user can specify or select options for generating a chart for particular data, and the dynamic chart generation module 202 can generate a chart within the UI based on the options. The user can subsequently change some or all of the options for generating a chart, and the dynamic chart generation module 202 can dynamically update the chart within the UI based on the changed options. In this way, the dynamic chart generation module 202 can support dynamic switching between chart types and/or different data.

The chart type module 204 can provide various types of charts for displaying data. A chart type can indicate any chart that can provide a visualization of data. Examples of chart types can include a bar chart, a line chart, a pie chart, a funnel chart, a histogram, a scatter plot, a table, a cohort chart, etc. Many variations are possible. A user may select a chart type from available chart types. For example, available chart types can be provided in a toolbar, as described below in connection with the toolbar module 208. If a user does not select a chart type, a chart type can be selected for the user, such as a default chart type. In some embodiments, a chart type can be determined based on machine learning techniques, for example, as described in connection with a chart type determination module 252, explained below.

The chart data module 206 can provide various types of data for displaying in a chart. Data for displaying in a chart can include any type of data that can be visualized using a chart. In some embodiments, a chart can display data associated with one or more events, one or more attributes, a time window, etc. An event can indicate any data to be displayed in a chart. Examples of events can include user activity, new user activity, page views, content views, application (“app”) installs, app launches, search, post comments, post reactions, post shares, purchases, unique purchases, add to cart, checkout, initiate check out, call-to-action selected, messaging application bot call-to-action selected, etc. Many variations are possible. Events can include standard events, such as events provided or predefined within a social networking system. Events may also include custom events, which may be created or defined by users. A chart can provide a visualization of one or more events. An attribute can indicate any information relating to an event. An attribute can be associated with an event. An event may be associated with one or more attributes. In some cases, an attribute can relate or apply to any event. In other cases, an attribute can relate or apply to a particular event. Examples of attributes can include gender, age, language, traffic source, region, unique users, new users, stickiness, browser, browser version, device type, device model, device operating system (OS), app version, etc. Many variations are possible. A chart can provide a visualization of one or more attributes associated with one or more events. For example, an event may be broken down or split by one or more associated attributes in a chart. A time window or time frame can indicate a time period for which to provide a visualization of one or more events. For example, the time period can be specified in second(s), minute(s), day(s), week(s), month(s), year(s), etc. In some cases, the time period can include an entire time period associated with one or more events. For example, the time period can be specified as anytime or all. Data to be displayed in a chart can be dynamically changed. As an example, one or more events can be added or removed from a chart. As another example, one or more attributes can be added or removed from a chart. As an additional example, the time window can be changed for a chart. Data to be displayed in a chart can be changed using a toolbar, as described below in connection with the toolbar module 208.

The toolbar module 208 can provide a toolbar for selecting or specifying various options for generating a chart. The options for generating a chart can relate to chart types as well as data to be included in the chart. For example, the options for generating a chart can relate to chart types, events, attributes, and/or a time window. The toolbar can be provided within the UI for generating a chart. A user may specify values for one or more options for generating a chart using the toolbar. The toolbar can include one or more input UI elements relating to data to be displayed in a chart. Examples of input UI elements can include a text field, a text box, a selector, etc. In some embodiments, the toolbar can include respective input UI elements for chart types, events, attributes, and/or a time window. For example, the toolbar can include a text field for chart types, a text field for events, a text field for attributes, and/or a text field for a time window. A user may provide input relating to a chart type, an event, an attribute, or a time window in a corresponding input UI element in order to specify which chart type, event, attribute, or time window to display. In some embodiments, automated suggestions can be provided for various options for generating a chart as a user provides input in an input UI element, for example, as described below in connection with the auto suggestion module 210. In certain embodiments, respective drop down menus can be provided for various options that are available for chart types, events, attributes, and/or a time window. For example, the toolbar can include respective icons for providing options for chart types, events, attributes, and/or a time window, and the respective drop down menus can be provided in response to selection of the icons. For example, the toolbar can include an icon for chart types, an icon for events, an icon for attributes, and an icon for a time window. The user may select an icon in order to select an option available in connection with the icon. The respective icons for chart types, events, attributes, and a time window may be provided in proximity of the respective input UI elements for chart types, events, attributes, and a time window. In certain cases, the respective input UI elements for chart types, events, attributes, and a time window can be included in the respective drop down menus for chart types, events, attributes, and a time window and may be accessed in response to selection of the respective icons for chart types, events, attributes, and a time window. In some embodiments, the toolbar can include one input UI element for all options for generating a chart. For example, the toolbar can include a single text field for chart types, events, attributes, and a time window. Many variations are possible.

The auto suggestion module 210 can provide automated suggestions for various options for generating a chart. As explained above, options for generating a chart can relate to chart types, events, attributes, and/or a time window. In some embodiments, an input UI element for an option can be a text field or a text box. As a user enters text in the input UI element for an option, the auto suggestion module 210 can provide automated suggestions relating to the option. In some cases, as discussed herein, automated suggestions can also be referred to as “auto complete suggestions.” As an example, as a user enters text, such as one or more characters or words, in an input UI element for events, the auto suggestions module 210 can generate one or more suggestions relating to events based on the entered text. As another example, as a user enters text, such as one or more characters or words, in an input UI element for attributes, the auto suggestion module 210 can generate one or more suggestions relating to attributes based on the entered text. In some embodiments, the auto suggestion module 210 can generate suggestions for options that are related. For example, as a user enters text for an event in an input UI element, the auto suggestion module 210 can generate one or more suggestions relating to events as well as one or more suggestions relating to attributes based on the entered text. In some embodiments, a suggestion for an option can be provided based on substring matching. In other embodiments, a suggestion for an option for generating a chart can be determined based on natural language processing. For instance, the auto suggestion module 210 can attempt to determine which option a user intends to select based on entered text. As an example, the auto suggestion module 210 can support natural language queries entered by users. In certain embodiments, automated suggestions for options for generating a chart can be generated based on machine learning techniques. Many variations are possible. In this way, the auto suggestion module 210 can provide an “intelligent” automated suggestion or auto complete functionality.

The chart generation module 212 can generate a chart based on specified options. For example, various options can be specified or selected by a user using a toolbar within the UI, as described above. The chart generation module 212 can generate a chart based on the specified chart type, one or more events, one or more attributes, and/or a time window. If any of the options for generating a chart is not specified by a user, the chart generation module 212 can provide default options or determine appropriate options. The generated chart can be displayed within the UI. If the user changes some or all of the options for generating a chart, the chart generation module 212 can update the chart based on the changed options. The updated chart can be displayed within the UI. In this way, the chart generation module 212 can support dynamic switching between different chart types and/or different data. If the user does not change data to be displayed in a chart when changing the chart type, the data can remain the same or persistent while switching between the chart types. All examples herein are provided for illustrative purposes, and there can be many variations and other possibilities.

FIG. 2B illustrates an example chart type determination module 252 configured to train a machine learning model to predict a chart type for data, according to an embodiment of the present technology. In some embodiments, the chart type determination module 106 of FIG. 1 can be implemented with the example chart type determination module 252. As shown in the example of FIG. 2B, the example chart type determination module 252 can include a machine learning training module 254 and a machine learning evaluation module 256. In some cases, a user may specify various options for generating a chart for particular data, but may not specify a chart type. In these cases, the example chart type determination module 252 can determine a chart type for the particular data, for example, based on the type of the particular data. In some embodiments, the chart type for the particular data can be determined based on machine learning techniques. In other embodiments, the chart type for the particular data can be determined based on heuristics and/or rules.

The machine learning training module 254 can train a machine learning model to determine chart types for data to be displayed in charts. For example, data to be displayed in a chart can include one or more events. The one or more events may each be associated with one or more attributes. A type of data to be displayed in a chart can be determined based on an event, an attribute associated with an event, a combination thereof, etc. As discussed herein, a type of data can also be referred to as a “data type.” Examples of data types can include location, age, browsers, a particular browser, traffic, languages, a particular language, purchases, cities, etc. Many variations are possible. In some cases, a data type for particular data can be determined based on an event. If the event is purchases, the data type for the particular data can be considered to be purchases, and a chart type can be determined for purchases. In other cases, a data type for particular data can be determined based on an attribute associated with an event. For example, if the event is purchases, but the event is broken down by the attribute age, the data type for the particular data can be considered to be age, and a chart type can be determined for age. In certain cases, a data type for particular data can be determined based on a combination of an event and an associated attribute.

The machine learning training module 254 can train a machine learning model to predict a chart type for particular data based on a corresponding data type. Training data (e.g., labeled data) for training the machine learning model can include information relating to data, events, attributes, time windows, data types, etc. The training data can include labels corresponding to chart types. The training data can include various features. For example, features can relate to data, events, attributes, time windows, data types, users, etc. Features relating to users can include any attributes associated with users. Examples of user attributes can include a location (e.g., a country, state, county, city, etc.), an age, an age range, a gender, a language, interests (e.g., topics in which the user has expressed interest), a computing device associated with a user, an operating system (OS) of a computing device associated with a user, etc. Many variations are possible. The machine learning training module 254 can train the machine learning model to determine a score associated with one or more chart types. The machine learning training module 254 can retrain the machine learning model based on new or updated training data. For example, users may frequently change the chart type when a particular chart type is selected by the machine learning model for particular data. In such cases, training data can be updated to reflect user changes to the selected chart type.

The machine learning evaluation module 256 can apply the trained machine learning model to determine a chart type for data to be displayed in a chart. For example, the trained machine learning model can be applied to feature data relating to particular data to determine a chart type for the particular data. The trained machine learning model can output a score for various chart types. Chart types can include examples of chart types described above, for example, in connection with the dynamic chart generation module 202. Each score can be indicative of a desirability or suitability of the particular data being displayed using a corresponding chart type. The machine learning evaluation module 256 can order or rank different possible chart types based on respective scores. The machine learning evaluation module 256 can select a chart type having a top score for the particular data. In some embodiments, the machine learning evaluation module 256 can provide one or more chart types having scores that satisfy a threshold value for the particular data. Many variations are possible. One or more machine learning models discussed in connection with the dynamic data visualization module 102 and its components, such as the chart type determination module 252, can be implemented separately or in combination, for example, as a single machine learning model, as multiple machine learning models, as one or more staged machine learning models, as one or more combined machine learning models, etc.

The chart type determination module 252 can determine a chart type for particular data based on the trained machine learning model. As an example, if a user specifies locations as data to be displayed in a chart, the chart type can be determined to be a map. As another example, if a user specifies age as data to be displayed in a chart, the chart type can be determined to be a bar chart. As an additional example, if a user specifies browsers as data to be displayed in a chart, the chart type can be determined to be a bar chart showing a number of hits for all browsers. For example, a hit can indicate a request to a web server, for example, for a file. If the user specifies a specific browser as data to be displayed in a chart, for example, by drilling down or selecting a specific browser from the chart for all browsers, the chart type can be determined to be a line chart showing a number of hits for the specific browser. Many variations are possible.

In some embodiments, the chart type determination module 252 can determine a chart type for particular data based on heuristics and/or rules. For instance, the heuristics may indicate that a particular chart type used to visualize a particular data type. As an example, if the data type is location, the heuristics can indicate that a map should be used as a chart type. As another example, if the data type is age, the heuristics can indicate that a bar chart should be used as a chart type. Many variations are possible. In this way, the chart type determination module 252 can attempt to determine a chart type in which a user may want to see particular data. All examples herein are provided for illustrative purposes, and there can be many variations and other possibilities.

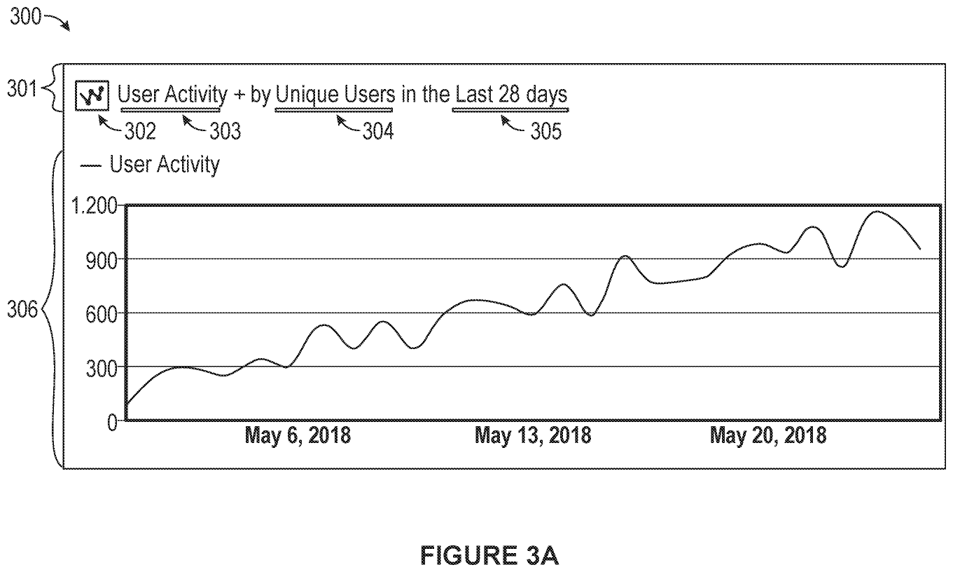

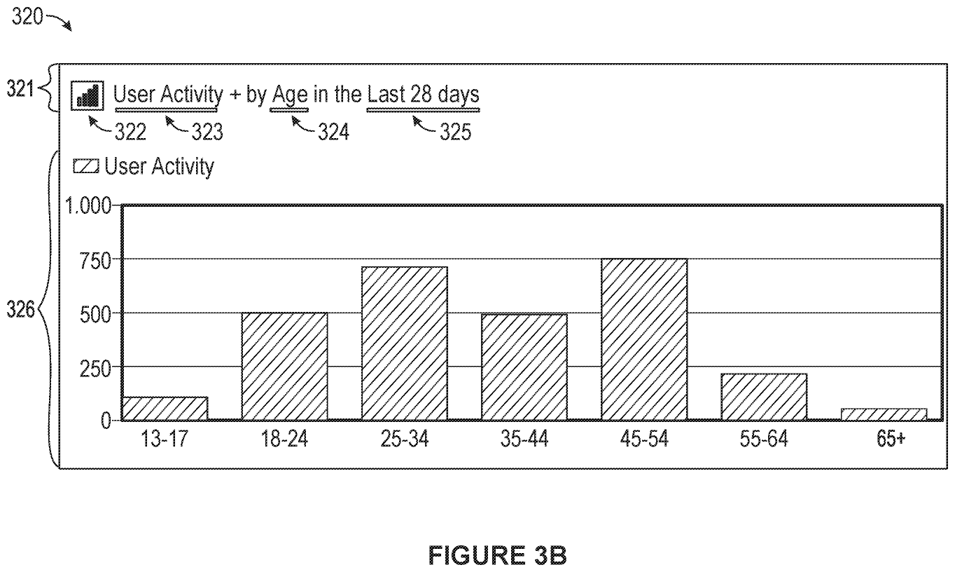

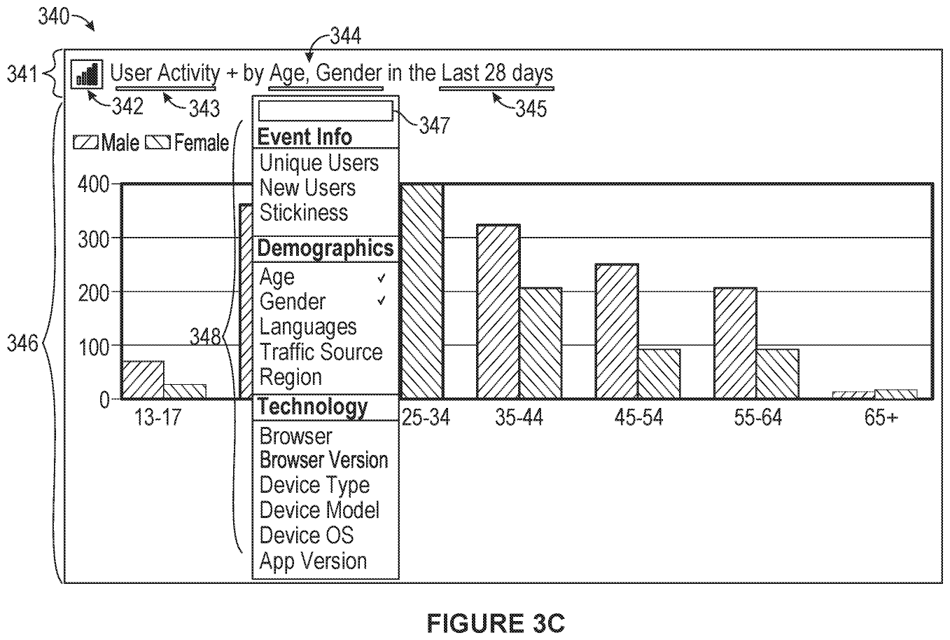

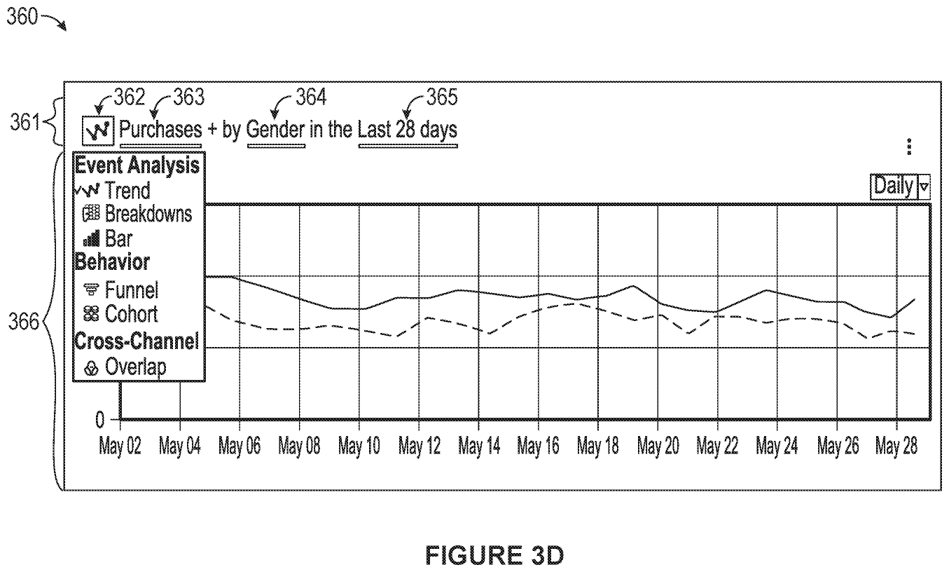

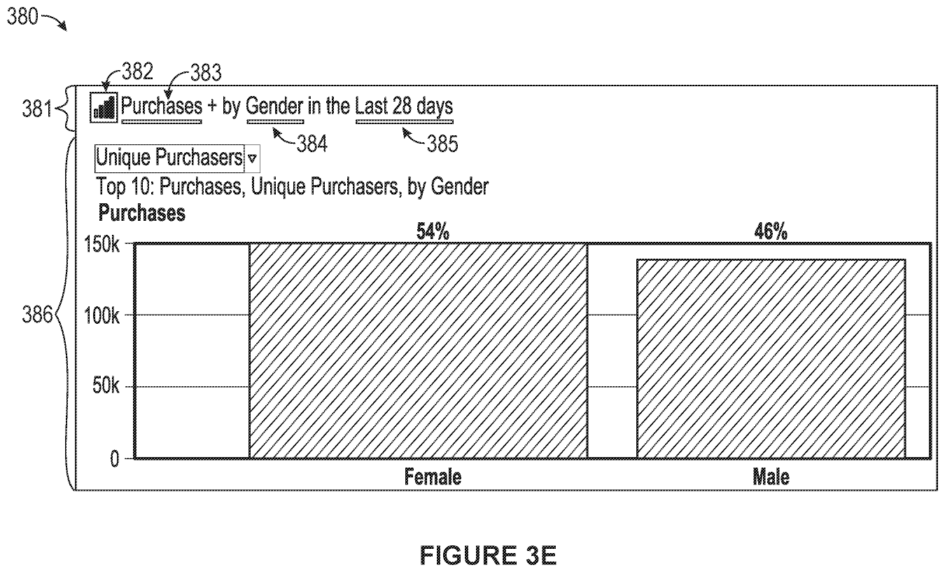

FIG. 3A illustrates an example user interface 300 for providing dynamic visualization of data, according to an embodiment of the present technology. The user interface 300 can include a toolbar 301 that allows a user to specify or select various options for generating a chart. In the example of FIG. 3A, the toolbar 301 includes a UI element for a chart type 302 (“chart type UI element”), a UI element for events 303 (“event UI element”), a UI element for attributes 304 (“attribute UI element”), and a UI element for a time window 305 (“time window UI element”). The user can specify or select options relating to a chart type using the chart type UI element 302. The user can specify or select options relating to events using the event UI element 303. For example, the user can specify or select one or more events. The user can specify or select options relating to attributes using the attribute UI element 304. For example, the user can specify or select one or more attributes. The user can specify or select options relating to a time window using the time window UI element 305. For example, the user can specify or select a time window. In the example of FIG. 3A, the chart type UI element 302 is an icon, and the event UI element 303, the attribute UI element 304, and the time window UI element 305 are drop down menus. In response to selection, a drop down menu may provide an input UI element and/or a list of available options. For example, the input UI element can be a text field or a text box. In the example of FIG. 3A, the chart type is a line chart. The selected event, the selected attribute, and the selected time window are “user activity,” “unique users,” and “last 28 days,” respectively. A chart 306 is generated based on specified options in the toolbar 301. For example, the chart 306 can be generated by the dynamic data visualization module 102, as discussed herein. All examples herein are provided for illustrative purposes, and there can be many variations and other possibilities.

FIG. 3B illustrates an example user interface 320 for providing dynamic visualization of data, according to an embodiment of the present technology. In the user interface 320, some of options for generating a chart are changed from the user interface 300 in FIG. 3A. For example, the chart type is changed from a line chart to a bar chart, and the attribute is changed from “unique users” to “age.” A user may change any of options for generating a chart. As an example, the user may change the chart type, add or remove one or more events, add or remove attributes, or change the time window. A toolbar 321, a chart type UI element 322, an event UI element 323, an attribute UI element 324, and a time window UI element 325 can correspond to the chart type UI element 302, the event UI element 303, the attribute UI element 304, and the time window UI element 305 in FIG. 3A, respectively. A chart 326 can be generated dynamically based on changed options for generating a chart. For example, the chart 326 can be generated by the dynamic data visualization module 102, as discussed herein. In the example of FIG. 3B, the chart 326 is a bar chart. In some embodiments, the chart type can be determined based on machine learning techniques, for example, by the dynamic data visualization module 102, as discussed herein. As an example, when the attribute is changed from “unique users” to “age,” the chart type can be determined to be a bar chart based on a machine learning model, instead of a user having to select the chart type. All examples herein are provided for illustrative purposes, and there can be many variations and other possibilities.

FIG. 3C illustrates an example user interface 340 for providing dynamic visualization of data, according to an embodiment of the present technology. In the user interface 340, some of options for generating a chart are changed from the user interface 320 in FIG. 3B. For example, the attribute is changed from “age” to “age” and “gender.” A toolbar 341, a chart type UI element 342, an event UI element 343, an attribute UI element 344, and a time window UI element 345 can correspond to the chart type UI elements 302, 322, the event UI elements 303, 323, the attribute UI elements 304, 324, and the time window UI elements 305, 325 in FIGS. 3A and 3B, respectively. In the example of FIG. 3C, the attribute UI element 344 is a drop down menu. The attribute UI element 344 has been selected and provides an input UI element 347. In some embodiments, the input UI element 347 can be a text field or a text box. The attribute UI element 344 can also provide available options for attributes 348 (“attribute options”). The attribute options 348 may be organized by categories. In some embodiments, as a user enters an input into the input UI element 347, automated suggestions can be provided based on the entered input. For example, automated suggestions can be generated by the dynamic data visualization module 102, as discussed herein. A chart 346 can be generated dynamically based on changed options for generating a chart. For example, the chart 346 can be generated by the dynamic data visualization module 102, as discussed herein. In the example of FIG. 3C, the chart 346 is a bar chart and is now broken down by the attributes “age” and “gender.” All examples herein are provided for illustrative purposes, and there can be many variations and other possibilities.

FIG. 3D illustrates an example user interface 360 for providing dynamic visualization of data, according to an embodiment of the present technology. A user can specify or select options for generating a chart using a toolbar 361. In the user interface 360, the chart type is a line chart. The selected event, the selected attribute, and the selected time window are “purchases,” “gender,” and “last 28 days,” respectively. The toolbar 361 can include a chart type UI element 362, an event UI element 363, an attribute UI element 364, and a time window UI element 365. The toolbar 361, chart type UI element 362, the event UI element 363, the attribute UI element 364, and the time window UI element 365 can correspond to the toolbars 301, 321, 341, the chart type UI elements 302, 322, 342, the event UI elements 303, 323, 343, the attribute UI elements 304, 324, 344, and the time window UI elements 305, 325, 345 in FIGS. 3A-3C, respectively. In the example of FIG. 3D, the chart UI element 362 is an icon, and a drop down menu for chart types is provided in response to selection of the chart UI element 362. In the example of FIG. 3D, chart types include “trend,” “breakdowns,” “bar,” “funnel,” “cohort,” and “overlap.” The option “trend,” which corresponds to a line chart, has been selected as the chart type. A chart 366 can be generated based on specified options in the toolbar 361. For example, the chart 366 can be generated by the dynamic data visualization module 102, as discussed herein. All examples herein are provided for illustrative purposes, and there can be many variations and other possibilities.

FIG. 3E illustrates an example user interface 380 for providing dynamic visualization of data, according to an embodiment of the present technology. In the user interface 380, some of options for generating a chart are changed from the user interface 360 in FIG. 3D. For example, the chart type is changed from a line chart to a bar chart. A toolbar 381, a chart type UI element 382, an event UI element 383, an attribute UI element 384, and a time window UI element 385 can correspond to the toolbars 301, 321, 341, 361, the chart type UI elements 302, 322, 342, 366, the event UI elements 303, 323, 343, 363, the attribute UI elements 304, 324, 344, 364, and the time window UI elements 305, 325, 345, 365. in FIGS. 3A-3D, respectively. A chart 386 can be generated dynamically based on changed options for generating a chart. For example, the chart 386 can be generated by the dynamic data visualization module 102, as discussed herein. In the example of FIG. 3E, the chart 386 is a bar chart. All examples herein are provided for illustrative purposes, and there can be many variations and other possibilities.

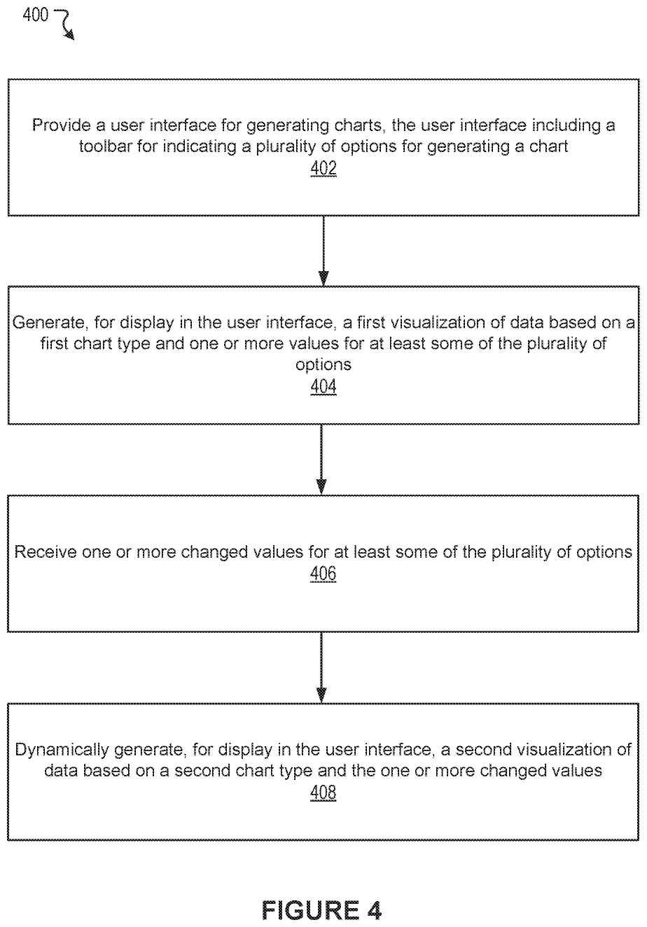

FIG. 4 illustrates an example first method 400 for providing dynamic visualization of data, according to an embodiment of the present technology. It should be understood that there can be additional, fewer, or alternative steps performed in similar or alternative orders, or in parallel, based on the various features and embodiments discussed herein unless otherwise stated.

At block 402, the example method 400 can provide a user interface for generating charts, the user interface including a toolbar for indicating a plurality of options for generating a chart. At block 404, the example method 400 can generate, for display in the user interface, a first visualization of data based on a first chart type and one or more values for at least some of the plurality of options. At block 406, the example method 400 can receive one or more changed values for at least some of the plurality of options. At block 408, the example method 400 can dynamically generate, for display in the user interface, a second visualization of data based on a second chart type and the one or more changed values. Other suitable techniques that incorporate various features and embodiments of the present technology are possible.

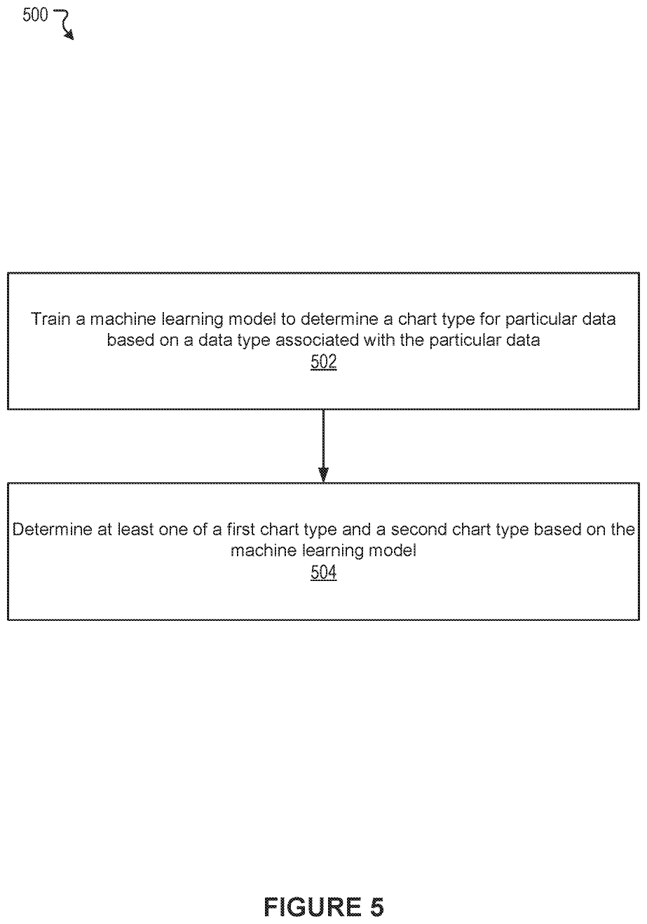

FIG. 5 illustrates an example second method 500 for providing dynamic visualization of data, according to an embodiment of the present technology. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can train a machine learning model to determine a chart type for particular data based on a data type associated with the particular data. At block 504, the example method 500 can determine at least one of a first chart type and a second chart type based on the machine learning model. Other suitable techniques that incorporate various features and embodiments of the present technology are possible.

It is contemplated that there can be many other uses, applications, features, possibilities, and/or variations associated with various embodiments of the present technology. For example, users can, in some cases, choose whether or not to opt-in to utilize the present technology. The present technology can, for instance, also ensure that various privacy settings, preferences, and configurations are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a dynamic data visualization module 646. The dynamic data visualization module 646 can be implemented with the dynamic data visualization module 102, as discussed in more detail herein. In some embodiments, one or more functionalities of the dynamic data visualization module 646 can be implemented in the user device 610.

### Hardware Implementation

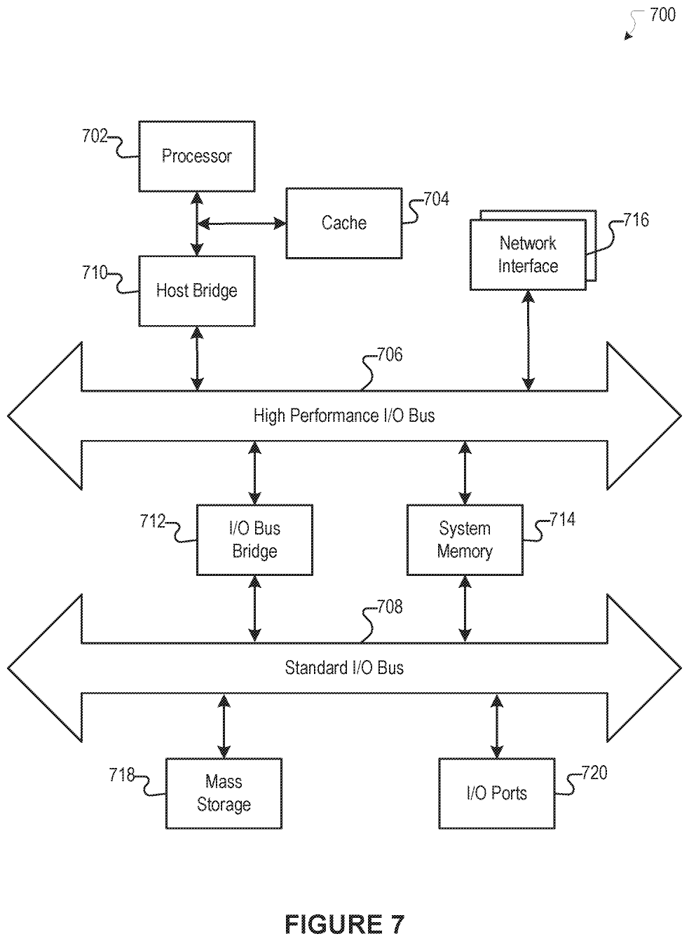

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
providing, by a computing system, a user interface for generating charts, the user interface including a toolbar for indicating a plurality of options for generating a chart;
generating, by the computing system, a first visualization of data associated with one or more events based on a first chart type and one or more specified values for at least some of the plurality of options, the first visualization of the data displayable in the user interface, wherein the first chart type is determined by a machine learning model based on a data type associated with the data and the first visualization provides the data split by one or more attributes associated with the one or more events;
receiving, by the computing system, one or more changed values for the at least some of the plurality of options; and
dynamically generating, by the computing system, a second visualization of the data based on a second chart type and the one or more changed values, the second visualization of the data displayable in the user interface.

2. The computer-implemented method of claim 1, wherein the second chart type is determined based on the machine learning model.

3. The computer-implemented method of claim 1, wherein the machine learning model is trained to determine a chart type for particular data based on a data type associated with the particular data.

4. The computer-implemented method of claim 1, wherein the data in the second visualization includes the one or more events.

5. (canceled)

6. The computer-implemented method of claim 1, wherein the first chart type and the second chart type include one or more of: a line chart, a bar chart, a pie chart, a funnel chart, a histogram, a scatter plot, a table, or a cohort chart.

7. The computer-implemented method of claim 1, wherein the plurality of options for generating the chart relates to one or more of: a chart type, an event, an attribute, or a time window.

8. The computer-implemented method of claim 1, wherein the one or more events include one or more of: user activity, new user activity, page views, content views, application installs, application launches, search, post comments, post reactions, post shares, purchases, unique purchases, add to cart, checkout, initiate check out, or call-to-action selected, and wherein the one or more attributes include one or more of: gender, age, language, traffic source, region, unique users, new users, stickiness, browser, browser version, device type, device model, device operating system (OS), or application version.

9. The computer-implemented method of claim 1, wherein the toolbar includes one or more input UI elements associated with the plurality of options, and wherein the method further comprises generating an automated suggestion for an input entered in the one or more input UI elements.

10. The computer-implemented method of claim 9, wherein the generating the automated suggestion is based on natural language processing.

11. A system comprising:
at least one processor; and
a memory storing instructions that, when executed by the at least one processor, cause the system to perform a method comprising:
providing a user interface for generating charts, the user interface including a toolbar for indicating a plurality of options for generating a chart;
generating a first visualization of data associated with one or more events based on a first chart type and one or more specified values for at least some of the plurality of options, the first visualization of the data displayable in the user interface, wherein the first chart type is determined by a machine learning model based on a data type associated with the data and the first visualization provides the data split by one or more attributes associated with the one or more events;
receiving one or more changed values for the at least some of the plurality of options; and
dynamically generating a second visualization of the data based on a second chart type and the one or more changed values, the second visualization of the data displayable in the user interface.

12. The system of claim 11, wherein the second chart type is determined based on the machine learning model.

13. The system of claim 11, wherein the machine learning model is trained to determine a chart type for particular data based on a data type associated with the particular data.

14. The system of claim 11, wherein the plurality of options for generating the chart relates to one or more of: a chart type, an event, an attribute, or a time window.

15. The system of claim 11, wherein the toolbar includes one or more input UI elements associated with the plurality of options, and wherein the instructions further cause the system to perform generating an automated suggestion for an input entered in the one or more input UI elements.

16. A non-transitory computer readable medium including instructions that, when executed by at least one processor of a computing system, cause the computing system to perform a method comprising:
providing a user interface for generating charts, the user interface including a toolbar for indicating a plurality of options for generating a chart;
generating a first visualization of data associated with one or more events based on a first chart type and one or more specified values for at least some of the plurality of options, the first visualization of data displayable in the user interface, wherein the first chart type is determined by a machine learning model based on a data type associated with the data and the first visualization provides the data split by one or more attributes associated with the one or more events;
receiving one or more changed values for the at least some of the plurality of options; and
dynamically generating a second visualization of the data based on a second chart type and the one or more changed values, the second visualization of the data displayable in the user interface.

17. The non-transitory computer readable medium of claim 16, wherein the second chart type is determined based on the machine learning model.

18. The non-transitory computer readable medium of claim 16, wherein the machine learning model is trained to determine a chart type for particular data based on a data type associated with the particular data.

19. The non-transitory computer readable medium of claim 16, wherein the plurality of options for generating the chart relates to one or more of: a chart type, an event, an attribute, or a time window.

20. The non-transitory computer readable medium of claim 16, wherein the toolbar includes one or more input UI elements associated with the plurality of options, and wherein the instructions further cause the computing system to perform generating an automated suggestion for an input entered in the one or more input UI elements.
